(19) United States
(12) Patent Application Publication
(10) Pub. No.: US 2002/0024424 A1
(43) Pub. Date: Feb. 28, 2002

(54) Civil defense alert system and method using power line communication

(76) Inventors: T. D. Burns, Guthrie, OK (US); Paul P. Burns, Preston (GB)

Correspondence Address: T.D. Burns, Post Office Box 60776, Oklahoma City, OK, 73146-0776, US

(21) Appl. No.: 09/827,634

(22) Filed: Apr. 6, 2001

Related U.S. Application Data
(60) Provisional application No. 60/196,511, filed on Apr. 10, 2000.

(51) Int. Cl. H04M 11/04

(52) U.S. Cl. 340/310.01

(57) ABSTRACT

This invention pertains to the use of power line communication in a civil defense alerting system. The idea encapsulates the use of existing technology both in power line communication via a power line modem and network data transfer and applies it to an area to which it has never before been applied. Substantial improvement to both is developed through this invention as the prior art had never included or addressed the need for and ability to communicate over the power lines when no electrical power was flowing from the utility.

The invention demonstrates that through a communications network it is possible for a system user to activate a single warning alerter device or a multitude of warning alerter devices that are connected to a standard power distribution network. Overall, this invention provides governmental users a more comprehensive and more fail-safe method and process f warning the public of risks, potentially hazardous situations, and safety instructions to minimize the loss of life and injury.

### CROSS REFERENCE TO RELATED APPLICATIONS

Not Applicable

### STATEMENT REGARDING FEDERALLY SPONSORED RESEARCH AND DEVELOPMENT

Not Applicable

### REFERENCE TO MICROFICHE APPENDIX

Not Applicable

### BACKGROUND OF THE INVENTION

1. Field of the Invention

This invention relates to an area, building, and/or device specific civil protection warning system that utilizes secure Internet communication, via an interdependent custom software gateway, to access standard power distribution network communication mediums interfacing with as few as a single polled electronic warning alerter device or with a multitude of polled electronic warning alerter devices to issue civil emergency alerts, instructions and warnings.

Description—Definitions

a. The definition ‘area specific, building, and device specific’ describes the discrete capability of a civil emergency warning process system to alert members of the public in a selected area, specific building, or adjacent to a specific alerter for large public areas or ways as determined by a computer in conjunction with an electrical power sub-station adjacent to or in an area of an impending or current civil emergency.

b. The definition of ‘Civil Emergency Warning Process System’ describes the corporate centralized telecommunications process system utilized as a carrier to transmit packets of digital information for the purpose of raising an alarm, alert, or warning to members of the public in the event of a Civil Emergency. These alarms, alerts, or warnings may relate to naturally occurring phenomena in Nature or to the expanding class of intentional and accidental man-made civil emergencies.

c. The definition of ‘Civil Emergency’ refers to any episode which is determined by authorized governmental agencies to constitute a major disruption or potentially major disruption to that which is commonly referred to as normal life for the affected area or any portion thereof. Civil Emergency can refer to naturally occurring phenomena in Nature such as tornadoes, earthquakes, hurricanes, floods, flash floods, wildfires, avalanches, or mudslides. Civil Emergency may also refer to the ever expanding multitude of potential intentional and accidental man-made incidents including attacks from conventional weapons of mass destruction by foreign or domestic forces; attacks from nuclear, chemical, or biological weapons of mass destruction by foreign or domestic forces; terrorism or other criminal activity; and accidents or incidents involving hazardous or toxic substances or materials which threaten human life and the environment.

d. The definition ‘Communication’ describes the transmission of polling data over the Internet and a Power Distribution Network (PDN) using from among predefined and/or prior patented technology.

e. The definition ‘Custom Software Gateway’ describes the 4WarnAlert software front end or entrance to the Civil Emergency Warning Process System described herein.

f. The definition of ‘Warning Alerter Device’ refers to cost effective, intelligent, plug in consumer devices capable of providing to the public, from among and individually or in combination, built-in visual, audible, and mechanical alerts to convey the warning or message processed by the Civil Emergency Warning Process System.

g. The definition of the ‘Internet’ is well known in the art.

h. The definition of ‘Polling’ describes an electronic method of remotely initiating a device to carry out a pre-defined task as well as sending the device supplementary information for the end user. The polling simply instructs the device to initiate the pre-defined task and at completion of the pre-defined task to stand by for possible real or live time supplementary information.

i. The definition ‘Standard Power Distribution Network’ refers to a standard Power Distribution Network as defined by the Institute of Electrical Engineers which further describes the standard 50 Hz AC 220/240 Volt electrical supply delivered by electrical power utilities to a standard Institute of Electrical Engineers power plug socket.

### BACKGROUND

2. Description of Prior Art

The evolution of Civil Defense warning process systems in the United States reached a historical and technical turning point during World War Two. The demands of a world war focused the Civil Defense mission on the processing of early warnings to alert the civilian populace of attack from external forces. The Cold War Era added the new threats of swift, intercontinental conventional and nuclear attacks. At the same time, natural and man-made civil emergencies re-emerged as an additional threat component included in the warning systems.

The hardware used for these tasks have included direct line message devices installed in military bases and public service departments, such as the fire and police. Existing systems continue to utilize fixed warning sirens and mobile public address systems mounted on government vehicles. Commercial radio and televison broadcast systems have also engrafted civil defense warning process systems. An incomplete chain of formal and informal inter-agency communication and warning methods has developed on an ad hoc basis. Technical obsolescence, budgetary constraints, cultural and demographic changes, shifting jurisdictional boundaries and evolving threat responder missions have all been factors which have led to a fragmentation and degradation of the ability to communicate a general or specific alarm to the public during civil emergencies.

Recognition of this shortfall in the essential need to communicate with the public before and during civil emergencies has been expressed throughout all levels of government. Compelled by Oklahoma's recent history of domestic terrorism and the first recorded F7 tornado, Oklahoma City Police Chief M. T. Berry recently took his concerns to the public and spoke of the need for enhanced warning process systems, especially during the non-wakeful periods. New threats to the public safety have developed: international and domestic terrorism; weapons of mass destruction including nuclear, chemical, and biological warfare; hazardous material incidents; and mass casualty events. Synoptic analysis of this problem by Civil Emergency professionals from all emergency services disciplines have concluded that the individual and the community are at their most vulnerable and subject to the greatest risk of being overwhelmed by a civil emergency during these non-wakeful hours. In this veiled state, the public is at the lowest point on the survivability graph.

A national dialogue was initiated by the United States in July 2000 with a roundtable to explore improving warnings process systems. During this roundtable, sponsored by the National Telecommunications Information Agency of the Department of Commerce, many of the deficiencies of current and evolving technologies have been noted. Fixed sirens have many significant disadvantages: inability to cover remote or sparsely populated areas; inability to communicate the exact nature of the threat or to convey precautionary instructions; inability to warn those within sound attenuating structures or in noisy environments; and ineffectiveness due to non-standardized meanings and lack of public understanding.

Mobile public address systems suffer from many of these same limitations and are also overly time consuming. Public address systems also divert personnel from the primary task of responding to and meeting the emerging threat. Commercial radio and televison broadcasts suffer the major disadvantage that large segments of the public, especially those in the sleep cycle or work environments without radios or televisions, may not be listening or watching. Use of electronic media to process civil protection warnings dangerously assumes that most of the public owns or has access to these appliances. Media broadcasts are also limited in effectiveness by the psychological desensitization that has occurred with the use of non-standardized warning sounds and symbols liberally laced with promotional materials and which are often active when no genuine emergency exists. Other devices such as barometric or seismic devices are designed purely for limited natural phenomena and do not cover the ever expanding multitude of potential man-made civil emergencies such as terrorist attacks, structure fires, floods, wildfires, and hazardous material incidents. This invention seeks to overcome these limitations and those of other prior efforts.

In 1979, Permut, et al proposed a Disaster Alert System, U.S. Pat. No. 4,155,042, which used a Central Disaster Alert Station and a plurality of disaster alert modules to notify threat responders and the public by radio. Until activated with a warning by the transmitter, the receivers remained quiet. As with other radio based systems, Permut's system was limited by transmission strength, geographic and terrain barriers, and reception barriers caused by structures or noisy environments. Permut's radio based system also lacks the ability to provide pinpoint warnings to small, limited danger zones and is not designed to issue a warning so precise as to target and reach only a single individual device.

Permut's system has no provision for direct interface with the warning process system by the authorized civil authorities at the affected national, state, county, or local level as all communications must first filter through a central disaster alert station. The recent initiative regarding weather warnings by the National Oceanic and Atmospheric Agency to build a nationwide network of radio transmitters to send activation signals followed by weather warnings to individual, commercially built and sold, radio receivers is limited by these same types of deficiencies.

An alert system for disasters inside of a structure was proposed in 1981 by Tai-her, U.S. Pat. No. 4,295,130, which included an audio visual alert using tape recorded messages. Tai-her's system is more of a building alarm with audio visual output for emergencies related solely to the wired building rather than a public disaster warning system. No interface is provided for governmental authorities to insert warnings of any emergency into this internal alarm system, even one involving the alarm building. In 1997, McGraw, et al, U.S. Pat. No. 5,628,050, envisioned a satellite based disaster warning communication system with personal receivers for use in isolated areas like islands and campgrounds. Although tied to satellites, it is still a radio based system with similar limitations. McGraw, like Permut and Tai-her, did not provide for direct interface with the system by national, state, county or local threat responders. All communications must be requested by such agencies through the owner or operator of the satellite uplink system.

By 1999, disaster alerts by telephone had entered the potential mix of components in the civil emergency warning process systems. Leichner's proposal, U.S. Pat. No. 6,002,748, (1999) is illustrative of telecommunications based systems. A recorded warning is sent to the public via their telephones. The most significant limitation on this type of system is that only those people who have phone service can be contacted. Almost as severe as this deficiency, telecommunications based warning process systems also suffer from the very slow rate of notifications with the reported maximum achieved speed of sixty calls per hour per dedicated phone line. Call screening, the non-universal availability of, subscription to, and lack of use of call waiting and psychological desensitization are other disadvantages of phone based systems cited in the roundtable regarding this type of system. Further, many telecommunications based systems only allow access to the agency that buys the hardware, system or service.

The use of message communication systems like pagers, illustrated by Beletic, et al, U.S. Pat. No. 5,706,211, (1998) rely upon radio or microwave transmissions with their inherent technological limitations. Additionally, a person must buy a pager and subscribe to a service in order to receive a warning. Concerns over the capacity of current structures to include and process warnings in addition to the other wireless services now associated with pagers were raised in the roundtable as well. Like the use of cellular phones for civil emergency warning systems, limitations in coverage areas and methods of warning users when roaming are significant disadvantages to reliance upon this type of technology. Similar limitations, starting with the need to have a computer and to be on line with the Internet, exist in regard to the Storm Ready Internet Service Provider Pilot for weather warnings. Like the broadcast media, the public must be on line and watching to receive this type of warning.

The concept of Power Line Communications (PLC)over Power Distribution Networks (PDN) is well known in the art. Huddleston, et al, described in 1988, U.S. Pat. No. 4,780,910, a new display for a remote receiver used in an electrical utility load management system over a PDN. One way communication over the PDN in the direction of the electricity flow was described by Hessling, Jr., in 1993 in U.S. Pat. No. 5,198,796. Ouellete offered a two way communication method and apparatus for use over a PDN to read electric meters and report back to a utility the account consumption in U.S. Pat. No. 5,945,239 (1996). In 1997, Bane offered his method and device for remotely accessing meter status information system for electrical utilities using two way PLC over a PDN in U.S. Pat. No. 5,684,472.

The concept of Power Line Communication over a Power Distribution Network to control a consumer's electrical devices was disclosed by Piercy, et al in U.S. Pat. No. 6,157,292 (2000). In a patent granted in 2000, U.S. Pat. No. 6,154,488, Hunt presented a system of two way PLC over PDN in order to control a consumer's electrical devices and to read the consumer's meter and report the information back to the utility. By way of a U.S. Pat. No. 6,177,884 granted in 2001, Hunt, et al, outlined an integrated two way PLC method and device for power line metering and transmitting of the information back to the utility with a new type of meter attached directly to the power line and without a visible meter readout.

In U.S. Pat. No. 6,172,597 (2001), Brown disclosed a PLC method over, preferably, underground power lines and a filter for telecommunication traffic as an adjunct to using dedicated telephone wirelines. However, none of these systems or apparatus envisage a warning system for use by governmental agencies to warn the public, especially during non-wakeful periods, of civil emergencies. The two objectives of these PLC over PDN systems are management of the electrical utility's load and billing efficiency. None of the prior art discloses a means of using the PLC for communications which result in communications recognizable by humans, except for Brown. Brown's system simply develops an alternate pathway for telecommunications. All of these systems require that the PDN have electricity flowing to consumers in order to operate, even those systems such as Hunt and Piercy which control a consumer's electrical appliances.

There are two instances of prior art which touch on other potentially relevant PDN issues. In a patent granted in 1984, Bennett, et al, U.S. Pat. No. 4,430,639, detailed the use of a visual message intercommunication unit and system allowing business communication between human users over PDN inside of a building. This method of two way communication is controlled by the owner of the system and requires all users to have mini-terminals similar to early personal computers. No interface was provided for communications from sources outside of the building. More recently, Bonsignore, et al, offered in a patent granted in 2000, U.S. Pat. No. 6,127,925, a signaling and/or help request system he describes as a surveillance system which uses, in part, Power Line Communication. Bonsignore presented a panic alarm device, similar to a remote garage door opener transmitter, which would transmit an alarm to a street lamp with transceiver. The street lamp device would transmit a message over the PDN connected to the street lamp to a receiving unit for channeling to appropriate agencies. Bonsignore noted that the system would be limited to high density population areas with integral lighting systems connected to a PDN. Remote or rural locations connected to a PDN would be excluded unless there was an integral lighting system connected to the PDN. Bonsignore's system also requires that the PDN be in operation with electricity flowing from the utility to the street lamps. Alternately powered lighting systems, such as solar, would be excluded. His system is a one way method which only allows a single individual to call for help. Bonsignore's system does not allow the consumer with the device or a multitude of consumers with the device to receive individually or by plurality a message from appropriate agencies regarding civil emergencies.

### SUMMARY

In accordance with the present invention, a civil protection warning process system is accessed through a secure Internet communication controlled by an interdependent custom software gateway which allows and assists authorized governmental agencies to decide on, select, and send civil emergency warnings over power distribution networks, whether or not electrical power is flowing from the utility to the consumers at the time, to a single or to a multitude of polled electronic alerter devices which provide visual, audible, and mechanical means of signaling the warning information to the public.

Objects and Advantages

Accordingly, besides the objects and advantages of civil protection warning process systems described in our above patent, several objects and advantages of our invention are as follows:

(a) to provide a civil protection warning process system with its inclusive alerter devices to save lives, prevent injury and minimize consequential loss;

(b) to provide a civil protection warning process system with its inclusive alerter devices to cover virtually all populated areas or any portion thereof, even remote or sparsely populated areas, utilizing Power Distribution Networks;

(c) to provide a civil protection warning process system with its inclusive alerter devices which can provide warnings to specific geographic areas, to a specific building, to a specific single alerter device or to an area adjacent to a specific alerter device location or a supplementary mass warning alerter device location including, but not limited, to large public areas such as streets, highways, parking lots, parks, auditoriums, theaters, shopping malls, arenas, or stadiums;

(d) to provide a civil protection warning process system with its inclusive alerter devices to all areas or any portion thereof served by a Power Distribution Network even if the electrical utility operating the PDN is not sending electricity through the PDN at the time a warning is initiated;

(e) to provide a civil protection warning process system with its inclusive alerter devices which is able to convey the appropriate warning to the public which can include the exact nature of the threat or risk, instructions, and the final All Clear status message;

(f) to provide a civil protection warning process system with its inclusive alerter devices which can warn the affected members of the public even if they are in sound attenuating buildings or noisy environments;

(g) to provide a civil protection warning process system with its inclusive alerter devices which utilize nationally standardized alert messages and warnings, but which is capable of providing real time, tailored, supplemental messages as needed;

(h) to provide a civil protection warning process system with its inclusive alerter devices which does not require time consuming or labor intensive efforts to operate so that the maximum number of personnel are available to respond to and meet the emerging threat;

(i) to provide a civil protection warning process system with its inclusive alerter devices which will be effective at all times of day or night, even during non-wakeful periods, does not require the public to listen or watch the alerter until it is activated, and can be used in work areas or other environments where radios or televisions are not permitted or practical;

(j) to provide a civil protection warning process system which utilizes in one embodiment an inexpensive alerter which an individual consumer with connection to a Power Distribution Network can install without technical assistance and which requires no consumer intervention for continuous operation;

(k) to provide a civil protection warning process system with alerter devices which do not desensitize the public as the device is only discernibly active in response to a civil emergency and provides only information relative to the civil emergency;

(l) to provide a civil protection warning process system with its inclusive alerter devices which provides the flexibility to be used in response to the ever expanding multitude of potential civil emergencies;

(m) to provide a civil protection warning process system with its inclusive alerter devices unaffected by distances, geography, terrain, signal strength or barriers caused by structures;

(n) to provide a civil protection warning process system with its inclusive alerter devices which allows around the clock, direct interface and control by authorized governmental agencies at the national, state, county and local levels;

(o) to provide a civil protection warning process system with its inclusive alerter devices which can provide virtually instantaneous contact with a single alerter device or a multitude of alerter devices as needed;

(p) to provide a civil protection warning process system with its inclusive alerter devices which is dedicated solely to civil emergency warning notifications without commercial messages or any transmissions which are unrelated to the operation of the warning process system or components thereof; and

(q) to provide a civil protection warning process system with its inclusive alerter devices which assists the authorized governmental users in the management of civil emergency responses by incorporation into the interdependent custom software gateway specialized tools including but not limited to: customized maps; satellite imagery; layering/scaling; chemical data bases; modern mathematical plume and weather prediction/modeling capabilities linked in real time to appropriate weather or environmental services; a foundational and relational data base centered upon census information for assistance in delineating warning/safe areas, evacuation numbers, and resources available/needed; and instant linkage to other governmental agencies.

Still further objects and advantages will become apparent from a consideration of the ensuing description and drawings.

### DRAWING FIGURES

FIG. 1 presents, in schematic form, the civil protection warning process system as a warning is sent from governmental users to the affected members of the public.

FIG. 2 graphically illustrates an example of processing a weather warning sent from a fixed base or static location of a government user to an alerter device in the affected area.

FIG. 3 graphically illustrates an example of processing a warning sent from one example of a mobile location by a government user to an alerter device within the affected area and demonstrates the inclusion of a supplementary mass warning alerter device controlled by the system.

FIG. 4 shows the data word.

FIG. 5 shows the architecture of an alerter device.

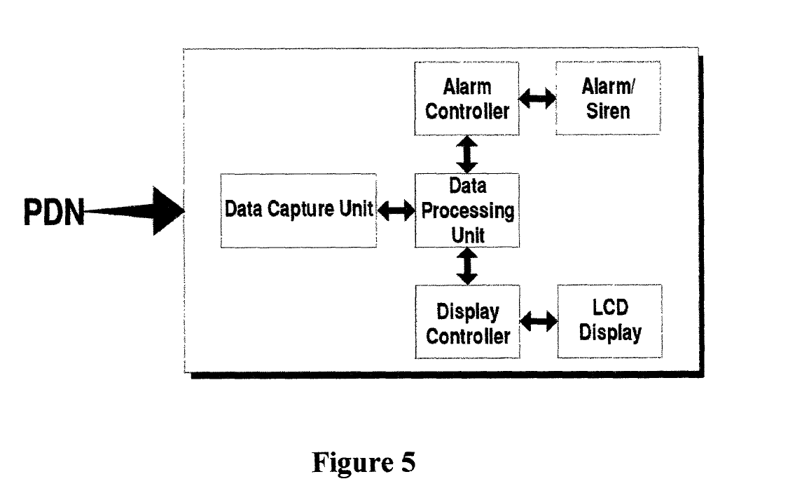

### REFERENCE NUMERALS IN DRAWINGS

1 4WarnAlert Server

2 Power Line Modem (PLM) at an electrical sub-station

3 4WarnAlert Alerter Device

3a Supplementary Mass Warning Alerter Device controlled by 4WarnAlert system

### DESCRIPTION

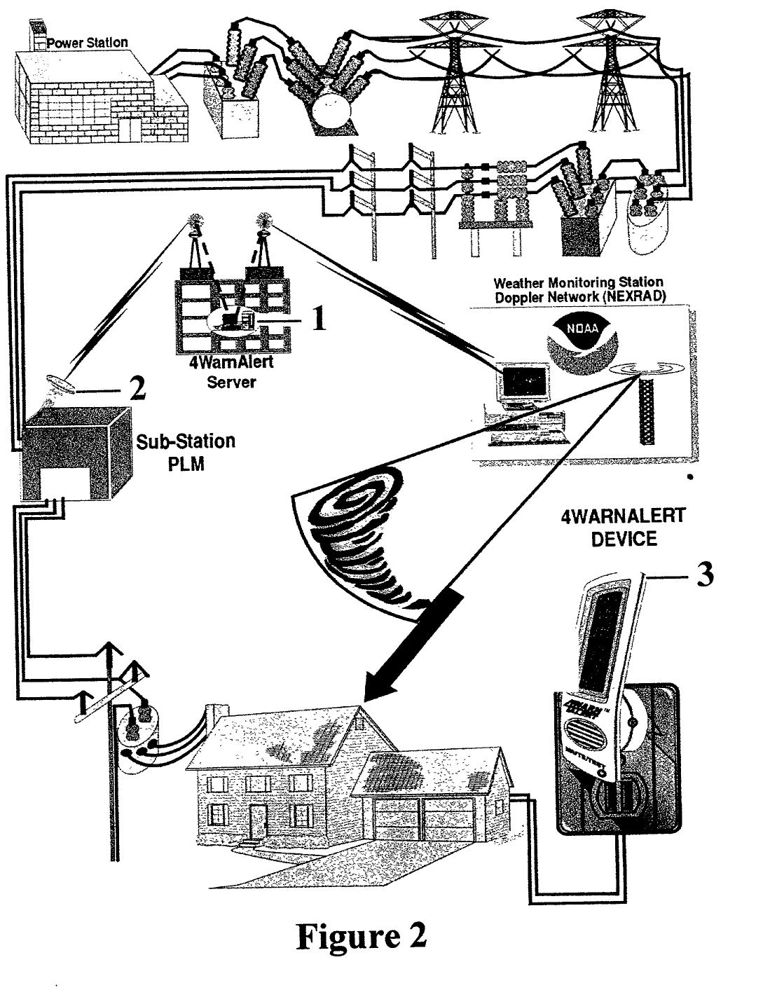

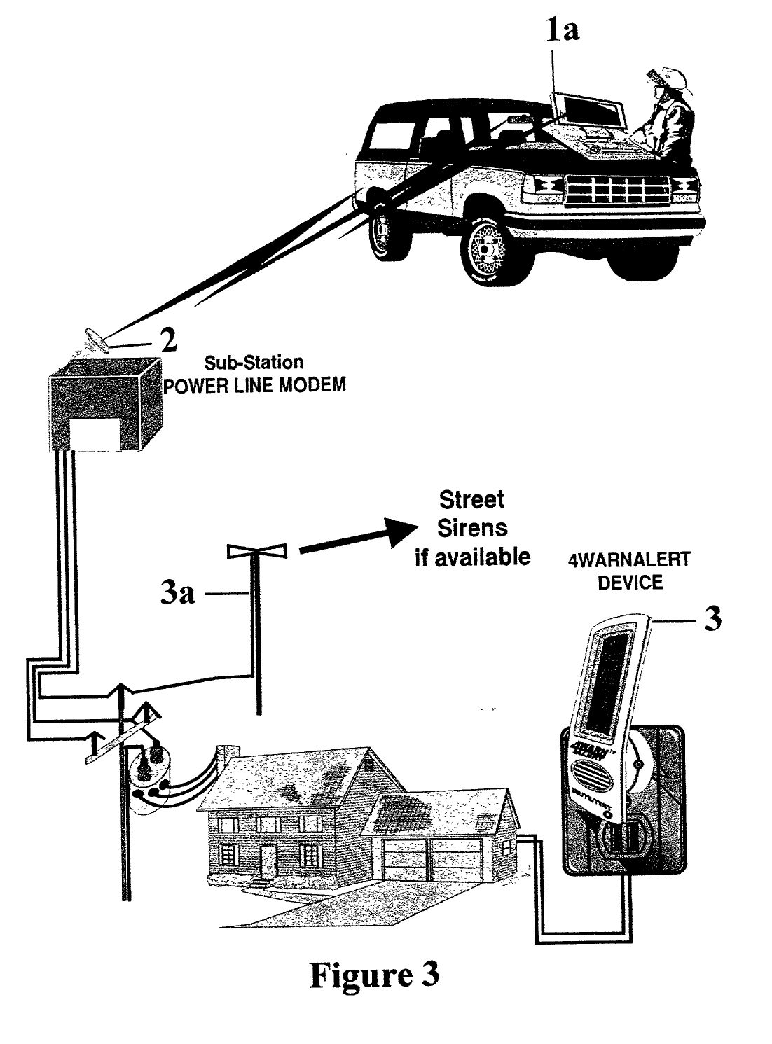

FIGS. 2 and 3

Preferred Embodiment

A preferred embodiment of this Civil Protection Warning Process System, as illustrated in FIGS. 2 and 3, has three components. The primary component (1) is a computer network interface which permits system access to various designated and authorized governmental users by means of a software front end or gateway (1). The gateway assists the user in establishing the parameters of the risk, the location(s) at risk, and directs a data packet to the secondary component (2) in the affected area.

The secondary component consists of the Power Line Modem (2) positioned at electrical substations to receive the digital data packet or alert object from the gateway and communicate the same over the standard power lines of a Power Distribution Network (PDN). The tertiary component is the warning alerter device (3) which is simply plugged into a standard electrical socket. When required to operate, the alerter device receives an activation or initiation data packet signal over the power lines causing an alarm or warning to be raised. The alerter device then stands by to receive real or live time supplementary information.

The 4WarnAlert gateway software acts as the process system management controller. It is written in secure java language so as to give the system great versatility and portability. Access for system users will be provided through standard Internet Service Provider (ISP) via any of the available connection technologies which are available in the user's location, which function with the user's mission, and allow for an Internet access from any point of presence. Alternatively, a specialized and custom Virtual Private Network (VPN) can be used in lieu of standard ISP in situations where the user's mission, location, or technology capability requires the same. Technology in these portions of the art are well known. A secure Internet connection is provided through the inclusion of a standard 128 bit encryption technique currently available to the public and currently utilized by in diverse applications such as on-line banking and workplace security systems.

Using a standard PC interface with any of the various Internet connection technologies and the specialized 4WarnAlert gateway software, the user accesses the system. Immediate and specialized password protection is programmed and constantly monitored for system integrity. Additionally, given the nature of the TCP/IP protocol, each computer interface connected to the Internet has a unique Internet Protocol (IP) address and this address is part of the second layer of security for this system. If the address does not match the designated user's address in the secure 4WarnAlert database, then access is denied and the connection is severed.

The gateway software also includes a graphical user interface (GUI) to declare specific physical or geographic areas at risk. The user selects a map location on the screen and indicates that the location is at risk. Integrated management software tools provide the user with options and assistance in the management of the risk and emergency. The software tools that the user can select from include customized maps; satellite imagery; layering/scaling; chemical data bases; mathematical plume and weather prediction/modeling capabilities linked in real time to appropriate weather or environmental services; a foundational and relational data base centered upon census information and pre-planning surveys to delineate warning or safe areas, evacuation numbers, potential routes, and resources needed/available; and instant linkage to other governmental agencies and users. Programming of this type is well known in the art and also relies upon java language for security, versatility, and portability.

Once the user has designated the area to receive the alert through the 4WarnAlert software, then the gateway (1) must interface with the secondary component (2), the Power Line Modem (PLM), to communicate the alert over the power lines. To do so, the gateway software (1) determines from the location of the danger compared to the actively updated, dynamic oracle relational database which electrical utility or utilities have Power Distribution Networks (PDN's) within the alert area. The information is contained in a standard look-up table format for fast processing. Once the relevant electrical utility power distribution network(s) is or are identified by the gateway software, then the software selects, with management options, which electrical power sub-stations must be notified through the PLM (2) in order to send the actuation signal over the power lines to the alerter device or devices (3). At this point, the software gateway (1) “knows” the time and type of alert message, the location of the at risk area, and the PDN and substations needed in order for the PLM (2) to communicate the warning to the alerter device or devices (3). This package of digital information is the “alert object”.

Encrypted software within the gateway (1) generates the actuation signal using the PC interface's RS 232 communication port to pass the information as normal data to the PLM (2). The actuation signal can be sent to the PLM (2)over any number of existent and/or the most efficient means available selected by the gateway from among telecommunications land lines, cellular telecommunications, microwave transmission or radio transmission. The PLM (2) has landline/telecommunication ports and antennae for radio, microwave and satellite reception. The PLM (2) has two sections: data receiving/relay transmitting and the carrier wave generator/transmitter.

The PLM (2) has a microprocessor which handles multiple tasks. At the instant of data receipt, the microprocessor determines whether or not the power line to the alert target is live flowing electricity from the utility to the device (s) location(s). If the microprocessor determines that there is no power flowing down the power line, then it instructs the carrier wave generator in the PLM (2) to use its internal battery backup to generate the signal and place the data on the carrier wave and apply it to all three out-going phase conductors from the sub-station to the alert target(s). In this way, transmission will only fail if there is a mechanical break in the power lines. If the microprocessor in the PLM (2) determines that the power lines are live, then it will instruct the PLM to place the data on the conductor of the existing power flowing over the power lines to the alert target(s) at the zero cross over point on the existing sine wave, either 50 Hz or 60 Hz so that there is no “noise” going over the line. As an added insurance, the software driving the message will continue to resend the message until it reaches a pre-programmed countermand.

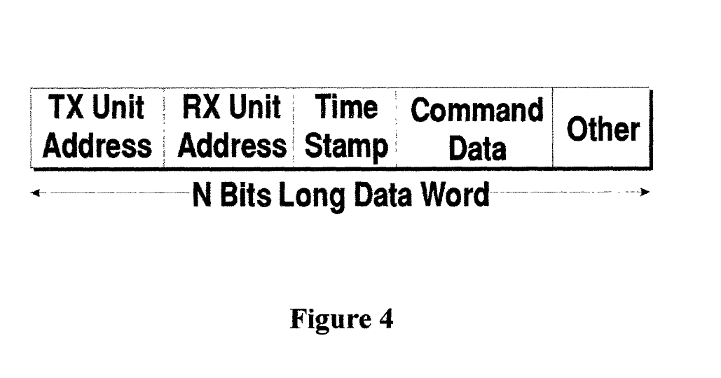

The alerter device (3), which is the ultimate alert target, can be housed in a variety of consumer friendly shells, representative illustrations of a non-mass alerter device are shown in FIGS. 2 and 3, which simply plug into any standard electrical socket. The alerter will consist of surface mounted components on an application specific PCB. FIG. 4 shows the architecture of a warning alerter device (3).

Each alerter will have a bar code identifier unique to its internal microprocessor chip to establish its IP to be recorded in the oracle database. At the time of insertion into the electrical plug, the microprocessor initiates a self test of the circuits and confirms it presence to the system. The alerter has a visible indicator that it is ready for use. The alerter, when activated, can use its color light system, like a traffic light, moving from the constant guardian or ready to operate amber to red for the warning and green for all clear. Equipped with a LCD scrolling message pad, with time and date stamp, standard or supplementary written messages can be shown for visual cues.

Electronic and mechanical devices within the alerter device can be used to generate audible warnings, such as sirens or voice, as well. The audible alarms are triggered in stages from the mute stage to high decibel perception levels. The audible alarm alternates with an electronically spoken advisory. A mute reset button accessible by the consumer is provided. The alerter is provided with a generic connection point that can be hooked to a plurality of devices already in use or available to the physically impaired such as an overhead lighting switch/blinking actuator for the hearing impaired or a bed shaker for the visually impaired.

Each alerter has an internal battery backup which is constantly trickle charged by the power socket to enable the operation of the alerter's fail safe alarm in the event of power failure and to provide a finite service for any warning messages in the event of power failure of the PDN. The internal portions of the alerter device are built so that they may be easily inserted into other housings to control mass alert devices such as sirens, electric roadway warning signs, mechanical roadway signs, and fixed public address systems.

The micro-controller in the alerter device (3) listens for the encrypted activation message or hand shake for a pre-determined number of times so that false alarms will be prevented. FIG. 4 illustrates the typical word data format that can be used. In this format, the TX Unit Address is the address of the unit sending the message. The RX Unit Address is the address of the alert target or specific alerter device(s) for which the message is intended. The Time Stamp is displayed and used to update the alerter visual display so as to prevent consumer /message confusion. The Command Data is the command operation that the alerter is tasked to carry our. It may be an actual formal warning or a system test alert. Once processed the alerter can act on this command. The alerter is also provided with a reset button that can be accessed by the consumer and by the system users. The “Other” refers to extra data that includes, but is not limited to, parity checks or error correction/ detection.

Once the threshold number of handshakes for activation is reached, then the microcontroller will perform the assigned task of locating the message from its pre-prograrnmed library of messages, when can be updated periodically by the gateway software (3), and initiates and displays the appropriate combination of output alerts. While continuing to perform the assigned task of displaying the first alert, the microprocessor also stands by to receive live time supplementary information and then perform the task of displaying the new output.

### OPERATION

Main Embodiment

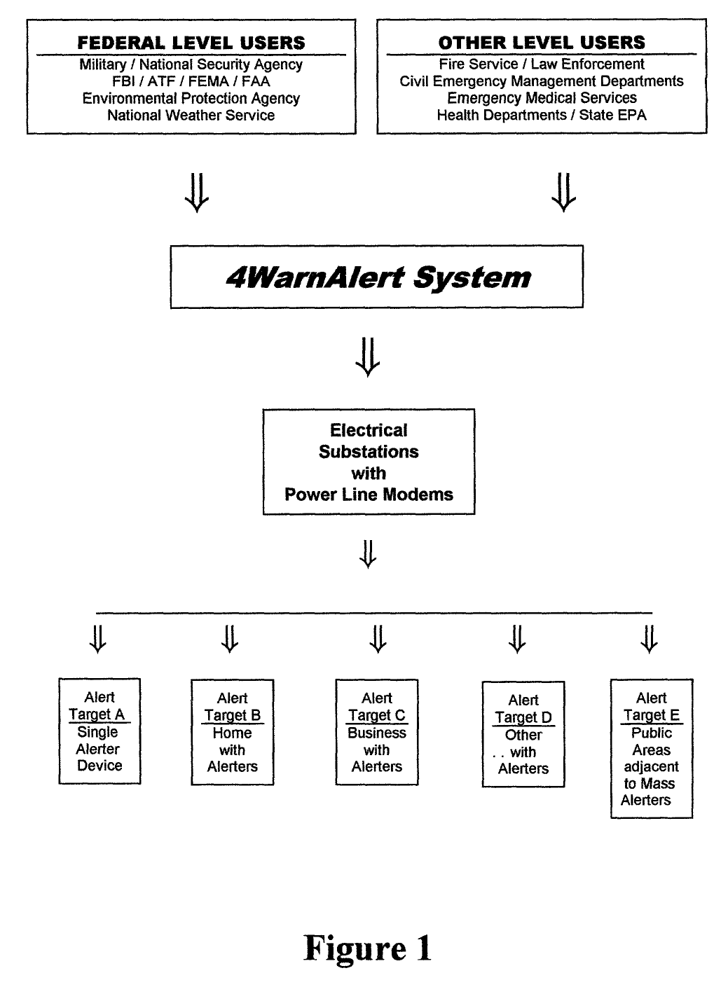

FIGS. 1 and 2 illustrate the operation of the main embodiment of the civil protection warning process system for a weather related civil emergency. The federal user agency, the National Oceanic and Atmospheric Agency (NOAA) or through its sub-agencies, the National Weather Service or the National Severe Storms Laboratory, detects the formation of a tornado. NOAA, as an authorized federal user of the 4WarnAlert warning process system, logs in to the gateway (1) software through a PC interface at its fixed location, a regional office. The gateway verifies that access is authorized for the user and that the IP address matches. NOAA can then select the locations or areas at risk and potential risk. NOAA would click on a map location to confirm identification by means of a graphical user interface—a computer generated map provided by the 4WarnAlert system process software and which is layered and scaled for zooming down to satellite and stereographic aerial photos to identify a single roof top or building—to indicate that the chosen area is at risk from a developing tornado. A marquee can then be pulled over the affected area or the user can select political boundaries such as county or city designations or even zip codes to establish the risk area for warning. A scroll down selection of standard emergency messages ready for dispatch would already be loaded in the gateway software (1) and have preprogrammed and up datable counterparts in the PLM (2) and the alerter devices (3). NOAA could further delineate the risk, level of severity, direction of travel, speed, or other factors relevant to the situation using the tools provided in the customized gateway software (1) which would be provided by a scroll down menu.

At the same time, the gateway software (1) determines the specific Power Distribution Network(s) which are in or adjacent to the risk areas. The gateway software (1) also identifies which designated electrical power sub-stations must be notified through the Power Line Modems (2) at the sub-stations to communicate the alert to activate the plug-in alerter devices (3). Within seconds, the 4WarnAlert process system has the data captured for the “alert object”—the time and type of alert, area (s) at risk, and the specific PDN (s) and PLM (s) (2) needed to activate the warning through the alerter devices (3). Using the available and most effective means of connecting, the PC interface sends the birth data to trigger the message.

NOAA's PC screen would show a shift from a green icon over the area to a pulsing red to show issuance and delivery of the alert. The marqueed area will switch to a cross-hatched red to amber and finally to green as the risk passes. This dynamic or sequenced action can also be actuated to sequence from no risk green to potential risk amber and red for the risk warning. If the NOAA user desires to send real time messages to all or part of the affected areas, then the user simply pulls down an interactive message board with a point size default set typeface with a message length limiter. The gateway software (1) tools will also allow the NOAA user to directly access mass alerters such as sirens which have been updated to include the alerter microprocessor. Additional pull down menus would allow linkage to other agencies such as local, county and state agencies in the affected areas.

Once the activation data packet is sent to the needed PLM(s) (2), the software and hardware encoding devices at the sub-stations will generate and/or inject the command signal for onward transmission, even when there is no power flowing over the PDN, to the alerters on that specific electrical sub-system and delivered via the power lines to the electrical socket where the alerter device is located. The alerter device performs the tasks commanded giving visual and audible warnings as required. When the risk passes, the alerter is reset by the system with the green all clear followed by a return to the guardian amber.

FIG. 3 illustrates a similar operation process when the initiating user sends from a mobile or changing position, in this case in response to a toxic gas cloud from an accidental release. The process and system remain the same with the user having additional, mission specific tools like plume modeling/prediction and instant weather reporting linkage, to manage the incident.

Alternative Embodiments

With the development of existing software, alternative embodiments exist for increasing the scope of this process and method. Alternatives can include: addition of an interactive alpha numeric message keyboard; swipe card facility on the alerter device; on board video camera; infra red detectors, and other surveillance and monitoring devices.

### CONCLUSION, RAMIFICATIONS, AND SCOPE OF INVENTION

In view of the above, it can be seen that the various objects and advantages of the features of this invention are achieved and other advantageous results are attained in an effort to provide the widest possible coverage of the “audience” of the public, especially during the non-wakeful periods. While not everyone has a computer hooked to the Internet, a cellular phone, a pager, a phone, a special weather radio, radio or television, virtually the entire populace has electrical service or is near a structure or public place with electrical service. Power Line based communication, which serves as a major portion communication warning infrastructure of this process and method, is improved for consumer safety with the addition of the ability to communicate from the Power Line Modem down the power line even when there is no electricity flowing form the utility to the “plug-in and forget” Alerter devices. This process and method provides governmental users an inherent flexibility, simplification of access, and instant assistance in the management of ever changing threat response in civil emergencies. As illustrated by the above information, the method and process of the 4WarnAlert system can save lives and prevent injuries, simply, efficiently and quickly whether the threat is to the elderly lady sleeping in rural Oklahoma as a tornado forms nearby or to an entire metropolitan area as a ship's cargo of toxic waste spills into the harbor.

While the above description contains many specifics, these should not be construed as limitations on the scope of the invention, but rather as one exemplification of one preferred embodiment of thereof. Many other variations are possible. For example, interactive message handling between members of the public and governmental user, interactive alpha numeric keyboard capabilities for emergency or routine messaging, surveillance and monitoring tasks, on board video camera for use by emergency service personnel to locate or assist victims or for use by law enforcement, and inclusion of infra red detectors for intrusion and fire alarms are some of the illustrative ramifications not specifically detailed above. Accordingly, these additional examples should not be interpreted in a limiting sense. The scope of the invention should be determined by the included claims and their legal equivalents, rather than by the examples given.

We claim:

1. A civil protection warning process system and method which provides authorized government users at the National, State, County, and Local levels a method to issue instant emergency warnings to the at risk members of the public through a system and method comprising:
(a) a software front end program or gateway to the system with access to a single warning alerter device or a multitude of warning alerter devices,
(b) a multitude of power line modems for electrical power sub-stations to receive warning signals and deliver the same using power line communication over power distribution networks to polled electric warning alerter devices and to so communicate whether or not there is any power flowing from the utility over the power distribution network power line so long as there is no mechanical break in the line system,
(c) a multitude of target or warning alerter devices connected to the power distribution networks for power line communication from the power line modems which said warning alerter devices can convey visual and audible warnings and real time safety messages or instructions upon command even in the event of a power disruption.

2. The software gateway of claim 1(a) wherein said software includes nationally standardized warnings and messages to enhance universal understanding by the public with minimization of panic impulses.

3. The software gateway of claim 1(a) wherein the comprehensive access provided and the integral emergency management tools provide the most flexible and adaptable warning process method and system for all types of civil emergencies.

4. The software gateway of claim 1(a) wherein said software is only used to activate the system during civil emergencies so as to avoid the desensitization associated with other warning process systems such as commercial media broadcast based systems.

5. The software gateway of claim 1(a) wherein said software allows 24 hour access to the system for government users so that effective warnings can be issued and comprehended even during non-wakeful periods.

6. The software gateway of claim 1(a) in combination with the power line modem of claim 1(b) and the warning alerter device of claim 1(c) provide instantaneous warning and alert communication to a single specific alert target warning device or to a multitude of warning alerter devices, dependent upon the dynamics of the emergency incident, by identifying the unique address of an alerter device or plurality of alerter devices in the risk area(s) via internal microprocessors and relational databases.

7. The power line modem of claim 1(b) wherein the internal microprocessor and carrier wave generator can send ultra narrow bandwidth digital information by modulation and addition of a high frequency wave to trigger a single alerter device or a multitude of alerter devices.

8. The power line modem of claim 1(b) wherein the inclusive carrier wave generator, internal finite power supply, and microprocessor can operate to send alerts over the powerlines even when there is no electrical power flowing from the utility.

9. A combination of the gateway software in claim 1(a) and the power line modem of claim 1(b) wherein multiple methods to communicate with the power line modem can be used to access the power line modem and to communicate so as to avoid the previous limitations of geography, distance, terrain, signal strength or structural barriers.

10. The target or warning alerter device of claim 1(c) wherein the device delivers high impact, multiple warning methods upon activation to include visual color cues, written text messages, and increasing audible sirens/tones with alternating voice warnings to be effective inside of structures, noisy environments, and to be highly effective during non-wakeful periods through the use of said combinations.

11. The combination of the elements in claims 1(a)-(c) wherein a medium of almost universal availability or, at a minimum, adjacent accessibility, an electrical socket or plug connected to a live or inactive power distribution network is used to provide the largest possible public audience at all times of the day or night.

12. The warning alerter device of claim 1(a) wherein no special technical skills are needed for the public to install and activate the warning alerter device and for which no consumer intervention is needed for the continuous operation of the device.

13. The warning alerter device of claim 1(c) wherein the voice and LCD message pad provide the government users the ability to provide the public with the nature of the threat, safety instructions, and the final all clear messages to ensure greater public awareness and compliance.

14. The combination of the 3 elements in claim 1(a)-(c) which require as little as one user to operate the entire system so as to save valuable resources and manpower to directly respond to the threat and/or its aftermath.
